(19) United States
(12) Patent Application Publication
(10) Pub. No.: US 2007/0196781 A1
(43) Pub. Date: Aug. 23, 2007

(54) ORTHODONTIC CLOSED COIL SPRING ASSEMBLY AND METHOD OF USE THEREOF

(75) Inventor: Jason B. Cope, Dallas, TX (US)

Correspondence Address: AKIN GUMP STRAUSS HAUER & FELD, LLP, P O BOX 688, DALLAS, TX, 75313-0688, US

(73) Assignee: UNDER DOG MEDIA, LP, Dallas, TX (US)

(21) Appl. No.: 11/672,327

(22) Filed: Feb. 7, 2007

Related U.S. Application Data
(60) Provisional application No. 60/775,529, filed on Feb. 22, 2006.

(51) Int. Cl. A61C 3/00

(52) U.S. Cl. 433/18; 433/21

(57) ABSTRACT

An orthodontic tensioning assembly, comprising a tensioner attachment body having a first end and a second end, wherein the first end of the tensioner attachment body has an opening adapted to removably receive a dental anchorage structure, and wherein the second end of the tensioner attachment body is adapted to removably couple a tensioning element.

### CROSS REFERENCE TO RELATED APPLICATION

This application claims the benefit of U.S. Provisional Application Ser. No. 60/775,529, filed Feb. 22, 2006, entitled: ORTHODONTIC CLOSED COIL SPRING ASSEMBLY AND METHOD OF USE THEREOF by inventor Jason B. Cope [Attorney Docket No. 45128-P002V1].

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCES TO A “SEQUENCE LISTING”

Not applicable.

### BACKGROUND OF THE INVENTION

The present invention relates generally to orthodontic appliances and, more particularly, to orthodontic closed coil spring assemblies for providing durational corrective resistance forces for adjustment of a patient's teeth.

In today's modern orthodontics, spring assemblies are used to assist the orthodontist with the re-alignment of a patient's teeth. One such spring assembly is a closed coil assembly. A closed coil spring assembly includes a closed coil spring with an eyelet on either end. A standard closed coil spring assembly has a simple circular round eyelet. There exists a common problem with the application of the closed coil spring assembly. In one example, the eyelet used on either end of the closed coil spring is too small to be fixed into the head of an anchorage device. In another example, the eyelet used in either end is too large, such that the eyelet is easily dislodged from the head of an anchorage device after placement of the closed coil spring assembly.

In the event that the eyelet of a closed coil spring assembly is too small to be fixed into the head of an anchorage device, the closed coil spring assembly needs to be ligated directly onto the anchorage device. However, such a procedure has proven difficult and time consuming. In situations where the eyelet of the closed coil spring assembly is too large, one method to overcome the problem is to place a standard orthodontic O-ring (e.g., a round rubber gasket) over the eyelet and the head of an anchorage device to prevent dislodgement. However, placing a standard orthodontic O-ring over the eyelet and the head of an anchorage device is unhygienic and may provide a reservoir for food and debris to collect around the head of the anchorage device, thereby increasing the risk of infection of the anchorage device. Moreover, placing the O-ring is time consuming and does not provide sufficient attachment in all circumstances. Therefore, there exists a need for a superior design and configuration for the eyelet structure of orthodontic closed coil spring assemblies.

Recently, orthodontic closed coil spring assemblies have been utilized in connection with temporary anchorage devices (TADs). A TAD is a device that is temporarily fixed to bone structure for the specific purpose of enhancing and providing sufficient orthodontic anchorage either by supporting the teeth of the reactive unit or by obviating the need for the reactive unit altogether and which is subsequently removed after use. In orthodontics, a TAD refers to all variations of implants, screws, pins and implants placed specifically for the purpose of providing orthodontic anchorage and can be removed upon completion of biomechanical therapy. TADs are useful when applied in the correction of dental discrepancies, which include antero-posterior tooth movements, molar uprighting, and intrusion/extrusion of single and multiple teeth. TADs can also be useful in the correction of oral skeletal discrepancies.

In application of a closed coil spring assembly with a TAD, the same problem exists as described above, in that the eyelet of the closed coil spring assembly may be either too small or too large. The need for a better engaging and securement design and configuration having improved hygienic properties for the eyelet of closed coil spring assemblies are apparent with the application of TADs.

### BRIEF SUMMARY OF THE INVENTION

The present invention is directed to novel designs and configurations of the eyelet of a closed coil spring assembly utilized, but not limited only thereto, in orthodontic applications, particularly with the application of TADs.

According to one aspect of the present invention, the orthodontic closed coil spring assembly comprises a closed coil spring and a connecting plate attached to at least one end of the closed coil spring. In particular, the closed coil spring assembly in the present invention can be used in connection with TADs for corrections of dental and skeletal discrepancies.

The present invention provides a connecting plate comprising at least one geometric bore disposed therein. The bore is designed to be large enough for placing over the head of an anchorage device but yet sustaining proper engagement therewith. When the closed coil spring assembly is released and the coil spring pulls on the connecting plates such that the inner eyelet of each connecting plate is pulled toward the closed spring, the closed coil spring assembly slips toward the center of the closed spring and the outer eyelet of each connecting plate engages around the neck of the head of the anchorage thereby providing secured locking with the anchorage device.

In another embodiment of the invention, each connecting plate is a flexible lasso directly connecting to the closed coil spring. The flexible lasso can be easily looped over an anchorage head regardless of the head shape or geometry and locked with the neck of the anchorage head when the pulling force from the closed coil spring is applied, thereby tightening the lasso around the head of the anchorage device.

Another aspect of utilizing the invention is a connecting plate in the form of a hairpin clip, which comprises a clip and two press tabs connected to the clip. The hairpin clip can be easily placed onto the neck of an anchorage head and remains in a locking position.

Another aspect of the present invention is directed to the connecting plate in the form of a flexible wire which can be placed easily around the neck of an anchorage head, and the springy wire can embrace and lock with the neck of the anchorage head with a force of the flexible wire.

Yet another aspect of the present invention comprises a connecting plate such as a cap comprising at least one inner retention gasket or the like which can be placed over an anchorage head to lock the anchorage head with the closed coil spring. In addition, the present invention comprises a connecting plate wherein the closed coil spring is a stiff wiring hook which can be inserted into the hole of the neck of the implant, thereby locking the closed coil spring to the implant.

### BRIEF DESCRIPTION OF THE DRAWINGS

FIG. 1A is a top view of the plate design and configuration of the orthodontic closed coil spring assembly according to an embodiment of the present invention;

FIG. 1B is a top view of the plate design and configuration of the orthodontic closed coil spring assembly according to an embodiment of the present invention;

FIG. 2A is a top view of the orthodontic closed coil spring assembly in a first connected configuration with a dental anchorage according to an embodiment of the present invention;

FIG. 2B is a top view of an example of the orthodontic closed coil spring assembly locking with a dental anchorage according to an embodiment of the present invention;

FIG. 2C is a perspective view of the orthodontic closed coil spring assembly locking with a dental anchorage according to an embodiment of the present invention;

FIGS. 3A and 3B depict a flexible string attached to the closed coil spring and an application thereof according to an embodiment of the present invention;

FIGS. 4A, 4B, and 4C depict a hairpin clip connected to the closed coil spring and an application thereof according to an embodiment of the present invention;

FIGS. 5A and 5B depict a flexible hook connected to the closed coil spring and an application thereof according to an embodiment of the present invention;

FIGS. 6A, 6B and 6C depict a cap and gasket connected to a closed coil spring and an application thereof according to an embodiment of the present invention;

FIGS. 7A and 7B depict a wiring hook connected to a closed coil spring and an application thereof according to an embodiment of the present invention;

FIG. 8 depicts the orthodontic closed coil spring assembly in use with a orthodontic temporary anchorage device (TAD) according to an embodiment of the present invention; and

FIG. 9 depicts the orthodontic closed coil spring assembly in connection with an orthodontic palatal arch wire according to an embodiment of the present invention.

### DETAILED DESCRIPTION OF THE INVENTION

While the making and using of various embodiments of the present invention are discussed in detail below, it should be appreciated that the present invention provides for inventive concepts capable of being embodied in a variety of specific contexts. The specific embodiments discussed herein are merely illustrative of specific manners in which to make and use the invention and are not to be interpreted as limiting the scope of the instant invention.

The claims and specification describe the invention presented and the terms that are employed in the claims draw their meaning from the use of such terms in the specification. The same terms employed in the prior art may be broader in meaning than specifically employed herein. Whenever there is a question between the broader definition of such terms used in the prior art and the more specific use of the terms herein, the more specific meaning is meant.

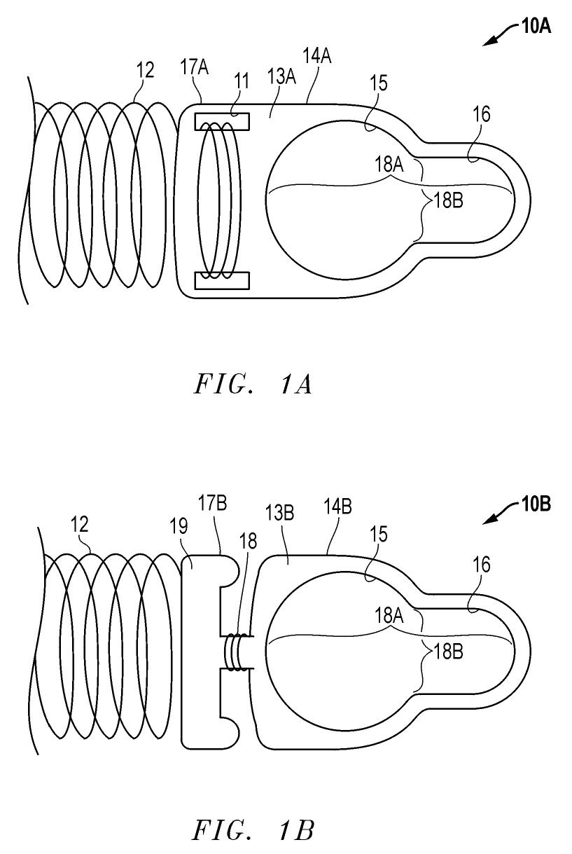

Referring now to FIG. 1A, an orthodontic closed coil spring assembly of the present invention is disclosed. In FIG. 1A, the embodiment of the closed coil spring assembly 10A comprises a closed coil spring 12 and a spring attachment plate 13A. The spring attachment plate 13A includes a spring attachment portion 17A and an anchorage connection portion 14A. As shown in FIG. 1A, the spring attachment portion 17A and the anchorage connection portion 14A of the spring attachment plate 13A are integrally formed as one piece. The spring attachment portion 17A comprises spring connecting apertures 11 for the attachment and removal of the closed coil spring 12. The spring connecting apertures 11 are so designed and configured that one end of the closed coil spring 12 can be passed through and firmly attached to the spring attachment portion 17A. The spring attachment plate 13A is manufactured from, but not limited to, stainless steel, titanium, titanium alloy, NiTi alloy, rubber, plastic, nylon, and/or carbon fiber. The closed coil spring is one type of shape-memory closed coil spring constructed from materials such as Titanium, Nickel-Titanium alloy, and/or stainless steel. The closed coil spring is of the kind commercially available from, but not limited to, Ultimate Wireforms, Inc.

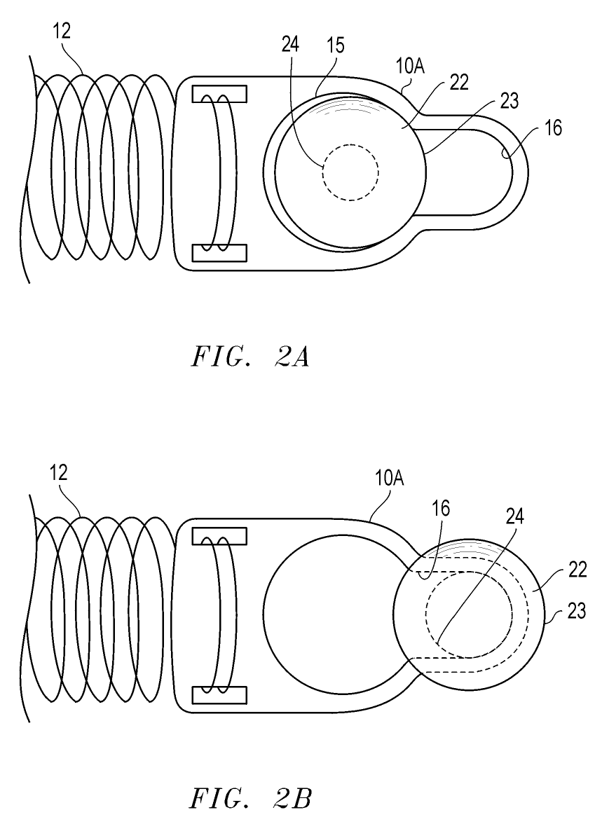

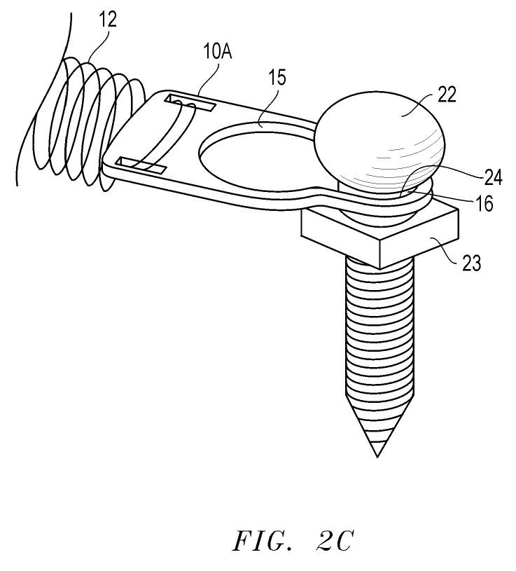

Also shown in FIG. 1A, the anchorage connection portion 14A comprises an aperture 18A wherein the aperture 18A defines an annulated bore, such that the aperture 18A comprises a first segment 15 and a second segment 16 wherein the first segment 15 comprises a bore larger than the bore of the second segment 16. However, one skilled in the art will readily understand that any shape whether used singularly or in combination with other shapes is contemplated by the present invention. As can be readily seen in FIG. 1A, the first segment 15 and the second segment 16 are adjacently disposed in such a manner to create an engageable channel 18B as will be described below. The diameter of the first segment 15 and the diameter of the second segment 16 are so designed and configured to allow the head 22 (as shown in FIGS. 2A and 2B) of a dental anchorage 23 to freely pass through the first segment 15 (as shown in FIG. 2A), to present locked engagement with the second segment 16 (as shown in FIG. 2B) when the closed coil spring 12 is tensioned.

Now referring to FIG. 1B, another embodiment of an orthodontic closed coil spring assembly 10B is shown. The orthodontic closed coil spring assembly 10B shown in FIG. 1B comprises a closed coil spring 12 and a spring attachment plate 13B having an anchorage connection portion 14B. The anchorage connection portion 14B comprises an aperture 18A as shown in FIG. 1A, wherein the aperture 18A defines a bore such that the aperture 18A comprises a first segment 15 and a second segment 16 wherein the first segment 15 comprises a bore larger than the bore of the second segment 16 and is connected by channel 18B. However, one skilled in the art will readily understand that any shape whether used singularly or in combination with other shapes is contemplated by the present invention.

The orthodontic closed coil spring assembly 10B shown in FIG. 1B further comprises a spring attachment portion 17B. As shown in FIG. 1B, the spring attachment portion 17B is integrally connected to the anchorage connection portion 14B by way of a neck portion 18 appending from the spring attachment portion 17B. The neck portion 18 is designed and configured for the attachment and removal of at least one end of the closed coil spring 12. Integrally extended from the neck portion 18 is an enlarged portion 19 of the spring attachment portion 17B. The enlarged portion 19 is designed and configured to reinforce the attachment of the closed coil spring 12 onto the neck portion 18.

A person of ordinary skill in the art will understand that the spring attachment portion 17B in FIG. 1B can be designed and configured in a plurality of configurations for the purpose of the attachment of at least one end of the closed coil spring 12. A person of ordinary skill in the art will also understand that the ends of the closed coil spring 12 can be attached to each of the spring attachment plates 13A and 13B as shown in FIGS. 1A and 1B, respectively, with other spring attachment plate designs.

An example of the orthodontic closed coil spring assembly 10A as depicted in FIG. 1A is shown and depicted in FIGS. 2A, 2B and 2C in a connected and locked relationship with a dental anchorage 23. The dental anchorage 23 can be, but is not limited to, a dental implant, a temporarily anchorage device, and/or a dental bracket hook (not shown). In FIG. 2A, a head 22 of the dental anchorage 23 is shown in an initial inserted connected position with the closed coil spring assembly 10A wherein the head 22 of the dental anchorage 23 is allowed to pass freely through the depicted first segment 15 and into the second segment 16 as described above and as shown in a locked position with the closed coil spring assembly 10A in FIG. 2B.

As shown in FIGS. 2A, 2B and 2C, the tension of the spring 12 urges the orthodontic closed coil spring assembly 10A to provide a positive pressure in a direction so that the second segment 16 engages with and generally embraces the neck 24 of the dental anchorage 23. Since the diameter of the bore of the second segment 16 is designed and configured to be smaller than the diameter of the head 22 of the dental anchorage 23 and substantially the same as the diameter of the neck 24 of the dental anchorage 23, the dental anchorage 23 provides locking capability with the orthodontic closed coil spring assembly 10A.

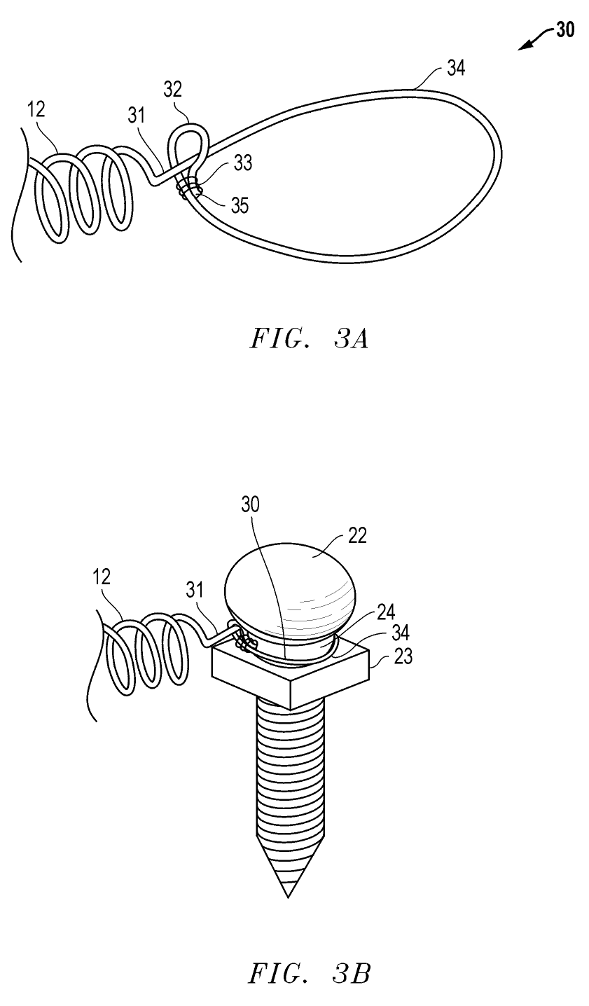

Now referring to FIGS. 3A and 3B, an embodiment of a flexible string 30 attached to the closed coil spring 12 and an application of such flexible string 30 are disclosed. This embodiment discloses a lasso-like flexible string 30 connected to the closed coil spring 12 and a dental anchorage 23. The flexible string 30 is manufactured from materials such as, but not limited to, stainless steel, titanium, titanium alloy, NiTi alloy, rubber, plastic, nylon, and/or carbon fiber. As shown in FIG. 3A, the flexible string 30 comprises a first end 31 of the flexible string 30 that is attached to at least one end of the closed coil spring 12. The flexible string 30 further comprises a second end 35 that loops back, wherein a closed loop 32 is formed on a second end 35 of the flexible string 30 to enable the first end 31 of the flexible string 30 to be inserted through the closed loop 32 of the second end 35. Specifically, as shown in FIG. 3A, the closed loop 32 is formed by connecting the second end 35 of the flexible string 30 to a portion of the flexible string 30 close to the second end 35. The connection is accomplished by utilizing but not limited to, a clip, tie, and/or knot generally indicated by 33 in FIGS. 3A and 3B. Also shown in FIG. 3A, the relationship between the first end 31 and the second end 35 of the flexible string 30 form a circular loop 34, which is designed and configured to be engaged with a dental anchorage as shown in FIG. 3B.

A person of ordinary skill in the art will understand that the method of forming the closed loop 32 for the first end 31 of the flexible string to be installed therein may vary. In addition, a person of ordinary skill in the art will further understand, that the length and size of the flexible string 30 is so designed and configured so that the circular loop 34 of the flexible string 30 can be easily manipulated and positioned onto a dental anchorage 23 and provide resilient dental wear and tear capabilities as shown in FIG. 3B. The flexible string 30 is manufactured from materials such as, but not limited to, stainless steel, titanium, titanium alloy, NiTi alloy, rubber, plastic, nylon, and/or carbon fiber.

With specific reference now to FIG. 3B, a flexible string 30 is shown connected to the dental anchorage 23. As shown in FIG. 3B, after the circular loop 34 of the flexible string 30 is positioned over the head 22 of the dental anchorage 23, the first end 31 of the flexible string 30 is pulled by a tensioning force exerted by the closed coil spring 12 such that the circular loop 34 of the flexible string 30 embraces the neck 24 of the dental anchorage 23, thereby providing locked engagement with the neck 24 of the dental anchorage 23.

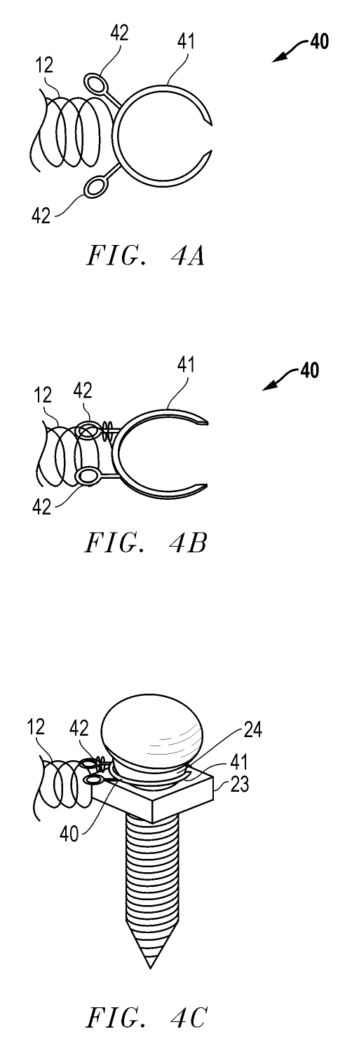

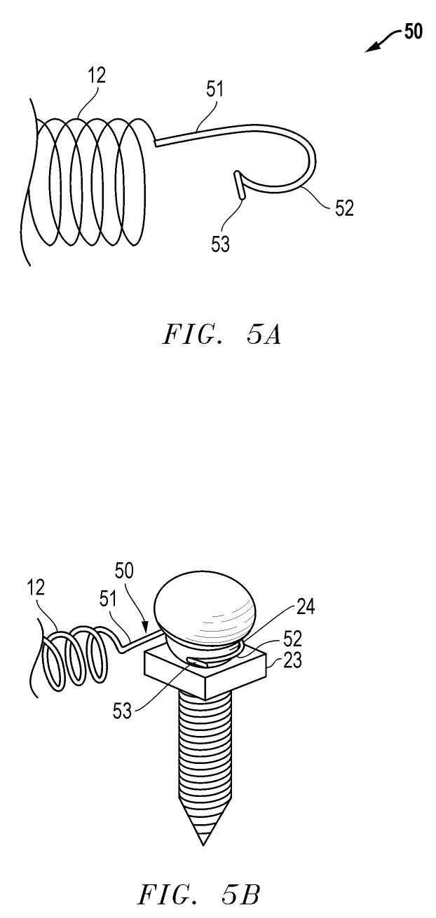

Now referring to FIGS. 4A, 4B, and 4C, one embodiment is shown depicting a hairpin clip 40 connected to the closed coil spring 12 and the application of such hairpin clip 40 according to the present invention. As shown in FIGS. 4A and 4B, the hairpin clip 40 comprises a clip element 41 and press tabs 42 connected to the clip element 41. FIG. 4A depicts the hairpin clip 40 in a closed configuration. A person of ordinary skill in the art will understand that the flexibility and the size of the hairpin clip 40 are so designed and configured so that the hairpin clip 40 can be operated with ease and placed onto a dental anchorage 23 or attachments thereon and positioned around the neck 24 of the dental anchorage 23 as shown in FIG. 4C.

FIG. 4B depicts an open configuration of the clip element 41 when the press tabs 42 are pressed toward one another. While in the open position, as shown in FIG. 4B, the hairpin clip 40 can be positioned onto and around the neck 24 of the dental anchorage 23 as shown in FIG. 4C. In FIG. 4C, when the hairpin clip 40 is in its locked configuration, the hairpin clip 40 engages and embraces the neck 24 of the dental anchorage 23 thereby providing locked engagement with the neck 24 of the dental anchorage 23. The clip element 41 of the hairpin clip 40 can be made of a rigid but flexible material such as, but not limited to, stainless steel, titanium, titanium alloy, NiTi alloy, rubber, plastic, nylon, and/or carbon fiber. In addition, the press tabs 42 of the hairpin clip 40 can be made of a rigid material such as, but not limited to, stainless steel, titanium, titanium alloy, NiTi alloy, rubber, plastic, nylon, and/or carbon fiber.

Now referring to FIGS. 5A and 5B, an embodiment of a flexible hook 50 connected to the closed coil spring 12 and an application of such flexible hook 50 according to the present invention are shown. As shown in FIG. 5A, the flexible hook 50 comprises an extension portion 51, a hook portion 52, and a tab 53 integrally connected to the end of the hook portion 52. The extension portion 51 is connected to at least one end of the closed coil spring 12. The hook portion 52 and the tab 53 possess a certain flexible property such that the flexible hook 50 can be operated with ease to be placed over the head 22 of a dental anchorage 23 as shown in FIG. 5B.

As shown in FIG. 5B, when the force of the closed coil spring 12 is exerted on the extension portion 51 of the flexible hook 50 away from the dental anchorage 23, the hook portion 52 of the flexible hook 50 lockably engages the neck 24 of the dental anchorage 23 to provide positional resiliency with the dental anchorage 23. The flexible hook 50 can be made of a rigid but flexible material such as, but not limited to, stainless steel, titanium, titanium alloy, NiTi alloy, rubber, plastic, nylon, and/or carbon fiber. The neck engaging portion of the hook portion 52 can be designed to be smaller than the neck 24 of the dental anchorage so that it reversibly engages the neck 24 of the dental anchorage.

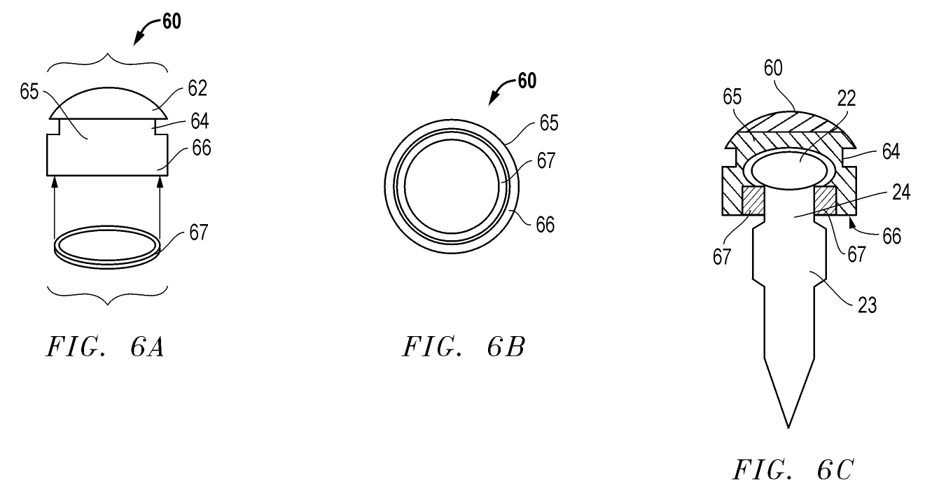

Now referring to FIGS. 6A, 6B, and 6C, an embodiment of a grooved cap 60 and an application herein are described according to the present invention. As shown in FIG. 6A, the grooved cap 60 comprises a cap portion 65 and a gasket 67. The cap portion 65 is one piece construction comprising a top portion 62, a neck portion 64, and a bottom portion 66. The gasket 67 is designed and constructed such that the inner diameter of the gasket 67 is slightly smaller that the diameter of the head of a dental anchorage 23 (as shown in FIG. 6C). As shown in FIG. 6B, a bottom view of the grooved cap 60, the cap portion 65 is a hollow structure comprising a cavity such that the gasket 67 is designed and configured to fit into the cavity of the cap portion 65 by permanently attaching the gasket 67 onto the inner wall of the cap portion 65, thereby forming the grooved cap 60. Not shown here, the grooved cap 60 may be directly ligated or connected to a closed coil spring by connecting one end of the closed coil spring onto the neck portion 64 of the grooved cap 60. The cap portion 65 is constructed from materials such as, but not limited to, stainless steel, titanium, titanium alloy, NiTi alloy, rubber, plastic, nylon, and/or carbon fiber. The gasket 67 is constructed from materials such as, but not limited to, rubber-based materials, conformable plastics, or the like, and materials comprising graphite components or the like.

Referring now to FIG. 6C, a section view of an embodiment of the present invention and the application of the grooved cap 60 is illustrated. In FIG. 6C, because of the conforming property of the gasket 67, the grooved cap 60 is fitted onto the head 22 and the neck 24 of the dental anchorage 23. As shown in FIG. 6C, the gasket 67 embraces the neck of the dental anchorage 23 and the cavity of the grooved cap 60 houses the head of the dental anchorage 23, thereby allowing the grooved cap 60 to remain in an engaged position with the dental anchorage 23.

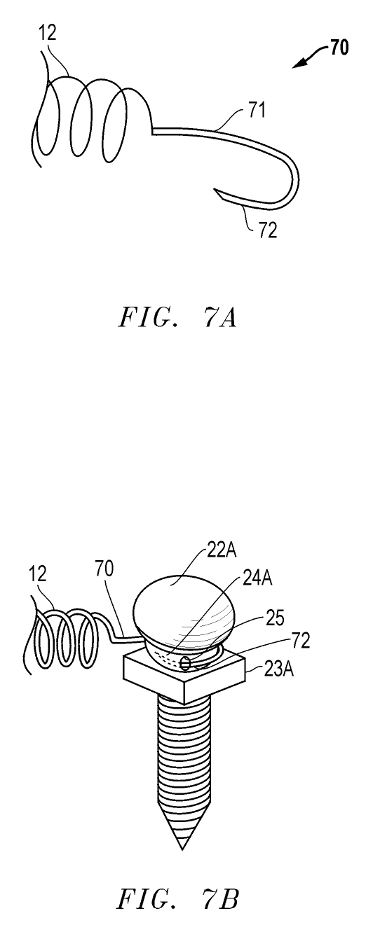

Now referring to FIGS. 7A and 7B, an embodiment of a wiring hook 70 connected to a closed coil spring 12 and an application of such wiring hook 70 according to the present invention are shown. As shown in FIG. 7A, the wiring hook 70 comprises a hook element 72 and a rod element 71 connected to at least one end of the closed coil spring 12. The wiring hook 70 is so designed and configured to be attached with a special designed dental anchorage 23A as shown in FIG. 7B.

In FIG. 7B, the dental anchorage 23A includes a head 22A and a neck 24A wherein an orifice 25 extends through a portion of the neck 24A of the dental anchorage 23A. The wiring hook 70 is designed to be placed around the neck 24A and then the hook element 72 is inserted into the orifice 25, thereby providing attached stability to the wiring hook 70 and the dental anchorage 23. The wiring hook 70 can be made of materials such as, but not limited to, stainless steel, titanium, titanium alloy, NiTi alloy, rubber, plastic, nylon, and/or carbon fiber.

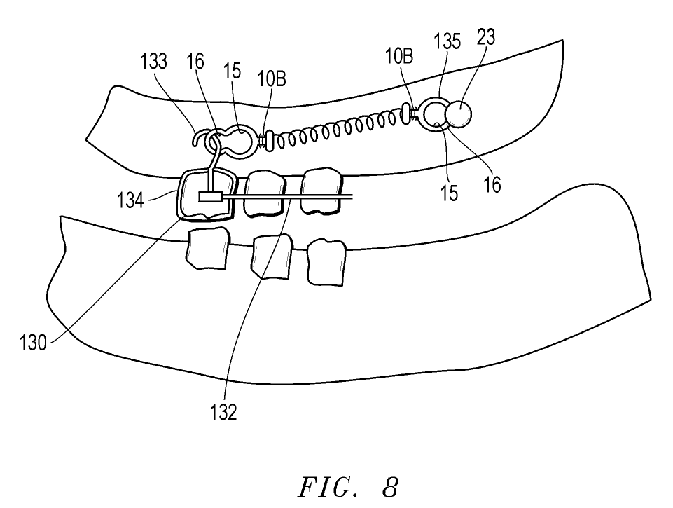

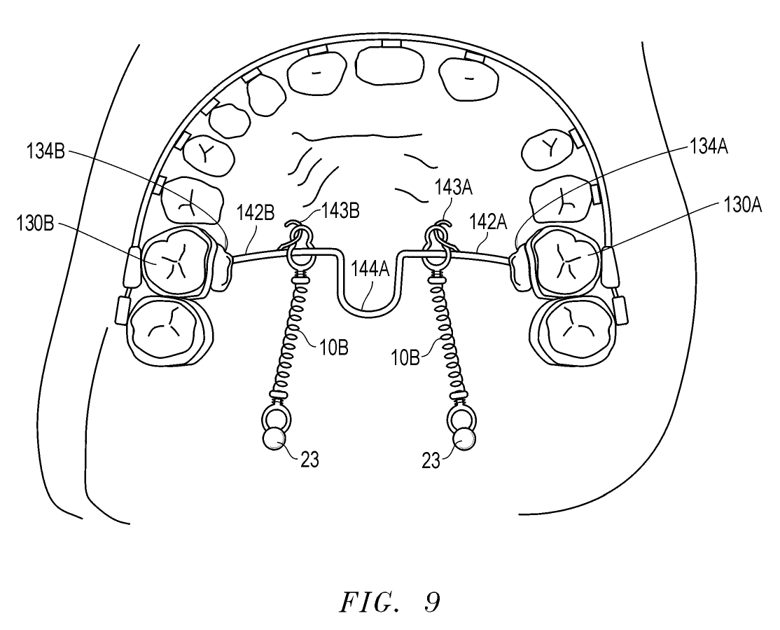

Now referring to FIG. 8, an application of one embodiment of the orthodontic closed coil spring assembly 10B is disclosed. A person of ordinary skill in the art will understand that any one of the embodiments of the orthodontic closed coil spring assembly (10A, 10B, 30, 40, 50, 60, or 70) described in the specification can be used for the purposes illustrated in FIGS. 8 and 9.

In FIG. 8, a bracket 134 and an orthodontic arch wire 132 are affixed to at least one maxillary tooth 130. A hook 133 is then connected to the bracket 134. A dental anchorage 23 (or 23A as shown in FIG. 7B) is placed into a maxillary bone (not depicted). The orthodontic closed coil spring assembly 10B is connected to the dental anchorage 23 (or 23A as shown in FIG. 7B) and the hook 133 of the bracket 134. By way of the first segment 15, the second segment 16 of one end of the closed coil spring assembly 10B engages with the neck 24 (not shown) of the dental anchorage 23 and the second segment 16 of an opposite end of the closed coil spring assembly 10B is engaged with the hook 133 of the bracket 134. When tension provided by the closed coil spring assembly 10B is applied in connection with the dental anchorage 23, the closed coil spring assembly 10B provides sufficient force to effectuate movement of at least one maxillary tooth 130.

Now referring to FIG. 9, another application using the orthodontic closed coil spring assembly 10B in connection with an orthodontic palatal arch wire 144A is disclosed. As shown in FIG. 9, a palatal arch wire 144A is installed into the upper jaw of a patient's mouth. Each end of the palatal arch wire 144A is connected to a bracket 134A, 134B which is mounted on opposing molars 130A, 130B. Hooks 143A and 143B are integrally connected to perspective arms 142A and 142B of the palatal arch wire 144A. Also shown in FIG. 9, dental anchorages 23 (or 23A as shown in FIG. 7B) are surgically positioned into the maxillary bone of a patient (not shown). The closed coil spring assemblies 10B are connected to hooks 143A and 143B on arms 142A and 142B of the palatal arch wire 144A and dental anchorages 23 respectively on the same side. With proper configuration, the closed coil spring assemblies 10B provide sufficient exerted force to the palatal arch wire 144A and toward the dental anchorages 23 to adjust direction of the force provided by the palatal arch wire 144A which in effect moves the opposing molars 130A and 130B as desired by the orthodontist.

A person of ordinary skill in the art will understand, that one or a plurality of closed coil spring assemblies 10B shown in FIG. 9 can be applied at desired angles and positions in connection with the usage of a palatal arch wire 144A or 144B to achieve ideal directional forces for adjusting the position of one or more of a patient's teeth.

Although the invention has been described with reference to specific embodiments, these descriptions are not meant to be construed in a limiting sense. Various modifications of the disclosed embodiments, as well as alternative embodiments of the invention will become apparent to persons skilled in the art upon reference to the description of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended Claims.

It is therefore, contemplated that the Claims will cover any such modifications or embodiments that fall within the true scope of the invention.

What is claimed is:

1. An orthodontic tensioning assembly, comprising:
a tensioner attachment body having a first end and a second end, wherein the first end of the tensioner attachment body has an opening adapted to removably receive a dental anchorage structure, and
wherein the second end of the tensioner attachment body is adapted to removably couple a tensioning element.

2. The orthodontic tensioning assembly of claim 1, wherein the tensioning element is a closed coil spring.

3. The orthodontic tensioning assembly of claim 1, wherein the dental anchorage structure is a temporary anchorage device (TAD).

4. The orthodontic tensioning assembly of claim 1, wherein the opening of the first end of the tensioner attachment body is formed of a plurality of annulated bores, connected by a channel.

5. The orthodontic tensioning assembly of claim 4, wherein the plurality of annulated bores is comprised of a first bore and a second bore, wherein the first bore is larger than the second bore.

6. The orthodontic tensioning assembly of claim 4, wherein the channel has parallel edges.

7. The orthodontic tensioning assembly of claim 5, wherein the first bore and the second bore are connected by an aperature defined by two straight edges extending therebetween tangents of the first bore and the second bore.

8. The orthodontic tensioning assembly of claim 7, wherein each of the two straight edges have protrusions disposed in an opposing relationship.

9. The orthodontic tensioning assembly of claim 1, wherein the second end of the tensioner attachment body has a plurality of openings adapted to receive and secure the spring.

10. The orthodontic tensioning assembly of claim 1, wherein the second end of the tensioner attachment body has a narrow region adapted to receive and secure the spring.

11. The orthodontic spring assembly of claim 5, wherein the dental anchorage structure is comprised of a head portion and a neck portion, the head portion being larger in diameter than the neck portion, and wherein the first bore is sized to receive the head portion and the second bore is sized to receive the neck portion.

12. An orthodontic spring assembly, comprising:
a spring attachment lasso, wherein the spring attachment lasso is adapted to be coupled to a closed coil spring, and the spring attachment lasso is configured to removably couple with a dental anchorage structure.

13. The orthodontic spring assembly of claim 12, wherein the lasso comprises a string having a first end and a second end, the second end comprising a closed loop, wherein the lasso is configured in such a manner that the first end is disposed within the closed loop of the second end.

14. An orthodontic spring assembly, comprising:
a spring attachment clip comprising a first end, a second end and a closed coil spring;
wherein the spring attachment clip is adapted to removably couple to the closed coil spring at the first end and the spring attachment clip is configured to removably couple to a dental anchorage structure at the second end.

15. The orthodontic spring assembly of claim 14, wherein the spring attachment clip is configured to expand in shape to enable engagement with the dental anchorage device, wherein internal tensile forces of the spring attachment clip enable securement of the clip to the dental anchorage structure.

16. The orthodontic spring assembly of claim 15, wherein a plurality of handles are affixed to the spring attachment clip to provide leverage for expanding the shape of the clip for engagement with the dental anchorage device.

17. An orthodontic spring assembly, comprising:
a spring attachment hook and a closed coil spring, wherein the spring attachment hook is adapted to be coupled to the closed coil spring at a first end and, wherein the spring attachment hook is configured to removably engage with a dental anchorage structure.

18. The orthodontic spring assembly of claim 17, wherein the dental anchorage structure comprises a neck having an orifice passing therethrough, wherein the spring attachment hook is configured to accommodate a portion of the hook to be inserted into the orifice for securement of the spring attachment hook to the dental anchorage device.

19. The orthodontic spring assembly of claim 17, wherein the spring attachment hook is configured to expand in shape to enable engagement with the dental anchorage device, wherein internal tensile forces of the spring attachment hook enable securement of the hook to the dental anchorage structure.

20. The orthodontic spring assembly of claim 19, wherein a handle is affixed to the spring attachment hook to provide leverage for expanding the shape of the hook for attachment to the dental anchorage device.

21. An orthodontic spring assembly, comprising:
a spring attachment cap;
a closed coil spring; and
a dental anchorage structure having a head and a neck, wherein the head is larger in diameter than the neck, wherein the spring attachment cap is adapted to be removably coupled to the closed coil spring, wherein the spring attachment cap is configured to removably attach to the dental anchorage structure by placement over the head of the dental anchorage structure.

22. The orthodontic spring assembly of claim 21, wherein the spring attachment cap comprises a gasket located in a groove of a spring attachment cap housing, wherein the spring attachment cap is adapted to receive the dental anchorage structure such that the head of the dental anchorage structure is secured in place by the gasket.

23. A method of providing durational corrective resistance force, comprising:
providing a tensioner attachment body having a first end and a second end, the first end having an opening adapted to removably receive the dental anchorage structure;
providing a tensioning element;
providing a dental anchorage structure;
inserting the dental anchorage structure into the opening of the tensioner attachment body; and
removably attaching the second end of the tensioner attachment body to the tensioning element.

24. The method of providing durational corrective resistance force as in claim 23, wherein the tensioning element is a closed coil spring.

25. The method of providing durational corrective resistance force as in claim 23, wherein the dental anchorage structure is a temporary anchorage device (TAD).

26. The method of providing durational corrective resistance force as in claim 23, wherein the opening of the first end of the tensioner attachment body is formed of a plurality of annulated bores, connected by a channel.

27. The method of providing durational corrective resistance force as in claim 26, wherein the channel has parallel edges.

28. The method of providing durational corrective resistance force as in claim 26, wherein the plurality of annulated bores is comprised of a first bore and a second bore, wherein the first bore is larger than the second bore.

29. The method of providing durational corrective resistance force as in claim 28, wherein the first bore and the second bore are connected by a void defined by two straight edges running between the tangents of the first bore and the second bore.

30. The method of providing durational corrective resistance force as in claim 29, wherein each of the straight edges has a protrusion disposed in an opposing relationship.

31. The method of providing durational corrective resistance force as in claim 23, wherein the second end of the tensioner attachment structure has a plurality of openings adapted to receive and secure the spring.

32. The method of providing durational corrective resistance force as in claim 31, wherein the second end of the tensioner attachment structure has a narrow region adapted to receive and secure the spring.

33. The method of providing durational corrective resistance force as in claim 23, wherein the dental anchorage structure is comprised of a head portion and a neck portion,
the head portion being larger in diameter than the neck portion, and
the first bore sized to receive the head portion and the second bore is sized to receive the neck portion.
